(19) United States
(12) Patent Application Publication
(10) Pub. No.: US 2010/0276515 A1
(43) Pub. Date: Nov. 4, 2010

(54) HAND SPRAY GUN FOR DETERGENT LIQUIDS

(76) Inventor: Pierantonio Milanese, Susegana (IT)

Correspondence Address: FRANCIS EDWARD MARINO, 394 MEREDITH NECK ROAD, MEREDITH, NH, 03253, US

(21) Appl. No.: 12/639,359

(22) Filed: Dec. 16, 2009

(30) Foreign Application Priority Data
May 4, 2009 (IT) PD2009A000117

(51) Int. Cl. B05B 9/01

(52) U.S. Cl. 239/302; 239/526

(57) ABSTRACT

A new spray gun comprising a body section equipped with a detachable container and hand pump for liquids. The device can be coupled with a detachable nozzle tip spray and/or an extension shaft equipped with a nozzle tip. The body section houses an additional socket for the nozzle or tip when not in use. The end part of the extension shaft, at the opposite end to the body section sealed inlet, is designed to house a coupling and locking device or attachment for a cleaning appliance.

### RELATED APPLICATION

This application claims the benefit of pending Italian Patent Application No. PD2009A000117 filed 04 May 2009, the entire teachings of which are incorporated herein by reference.

### DETAILED DESCRIPTION OF THE DRAWINGS

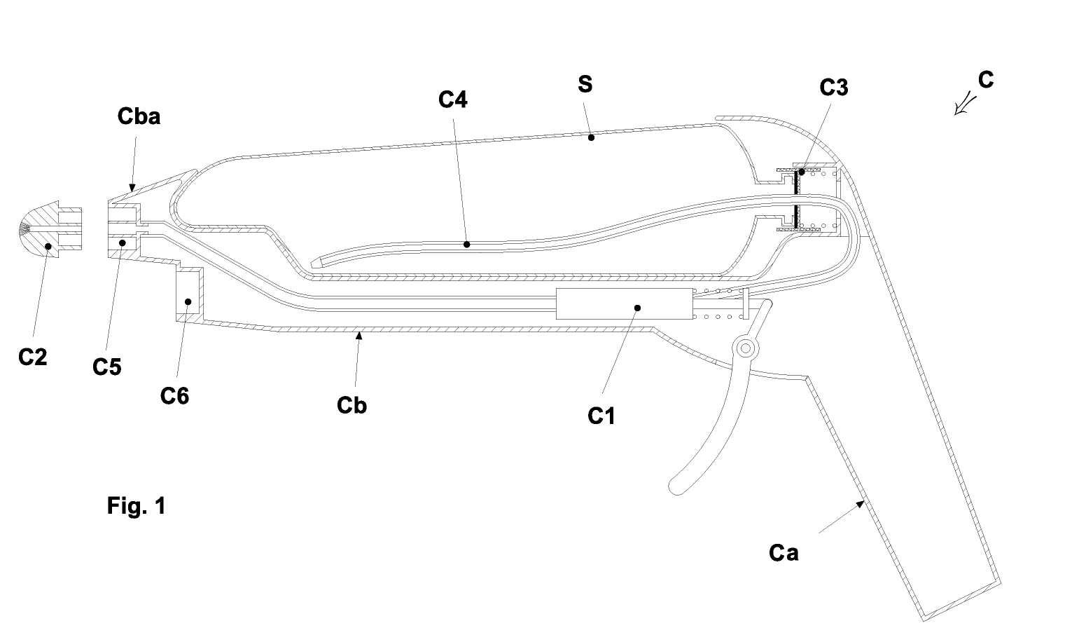

FIG. 1 is a cross-sectional view through a spray gun in accordance with the invention;

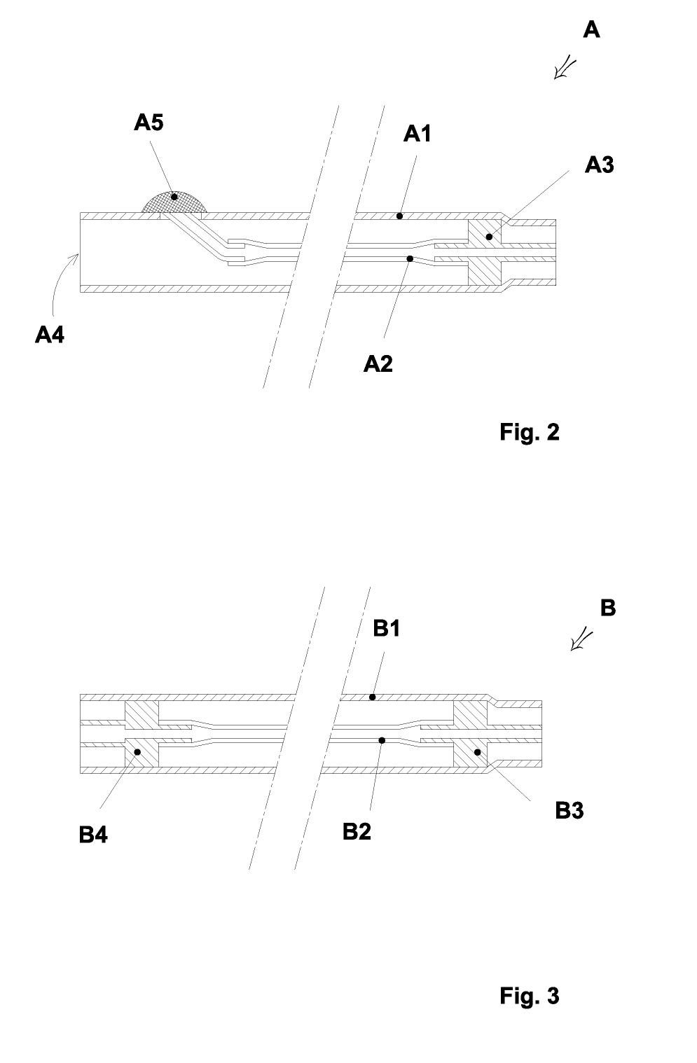

FIG. 2 is a cross-sectional view through an initial extension shaft for use with the spray gun of FIG. 1 in accordance with the invention; and

FIG. 3 is a cross-sectional view through a further extension shaft for use with the spray gun of FIG. 1 in accordance with the invention.

### DESCRIPTION

The present patent concerns household cleaning appliances and, in particular, a spray gun for liquids with a detachable tank and extension shaft.

Hand-held spray guns with containers are well known and generally comprise a bottle-shaped container with an upper 7-shaped handle. The lower part of the 7-shaped container contains the screw-in container, whereas the upper section comprises the spray nozzle.

The area normally horizontal to the 7-shaped section comprises a small pump connecting the nozzle to an immersion pipe extending down to the bottom of the vertical section of the tank. The pump is activated by a trigger mounted in the central section of the 7-shaped section.

Some hand spray guns are equipped with two types of nozzles for two types of spraying operations: a narrower, more direct spray or short-range nebulized spray.

These hand spray guns are cheaper, lighter, rechargeable and do not require a closure plug given that the pump carries out this function

The manual sprays comprise certain disadvantages.

In order to clean the floor of pollutants, the user is required to spray the cleaning liquid contained in the sprayer onto the surface of the floor area required to be cleaned. This is followed by a cleaning cloth to remove the dirt/pollutants and cleaning liquid. In order to carry out such an operation, the operator is required to bend down or kneel in order to spray the liquid with the spray gun in one hand, and, in order to remove the dirt and cleaning liquid, with a cloth in the other hand. Otherwise, the user is required to lean down in order to spray the cleaning liquid; with the spray gun in one hand whilst removing the dirt and cleaning liquid with the instrument described earlier (comprising a handle with a cleaning cloth holder head and cloth attached).

Whatever the case, the user has both hands employed. One hand is holding the spray gun whereas the other hand is holding the cleaning cloth or the tool (comprising handle and cleaning cloth holder head). The present patent regards a new spray gun device for liquids with a detachable container, which can be employed together with one or more extension shafts.

One specific purpose of the new spray gun is the fact that it can be coupled to at least one extension shaft.

A further advantage lies in the fact that it can be attached to an extension with nozzle.

Finally, the spray gun can be employed either with an extension shaft or as a simple hand-held spray gun.

The above purposes—both direct and indirect—are achievable thanks to the new spray gun which comprises a body, with detachable container and liquid hand pump, which in turn can be attached either to a detachable nozzle and/or an extension shaft in turn equipped with a spray nozzle.

The body comprises two parts inclined towards one another. One part is made up of the handle which allows the user to grip the body. The second part is U-shaped and consists of 5 slot socket to allow the detachable container to be attached. The socket includes a sealed inlet to connect the liquid container part to the handle. The inlet is also equipped with an immersion pipe to feed the liquid from the container to the nozzle. The central part of the body houses the pump for liquids. The pump is connected to the container via an immersion pipe and to the rapid sealed inlet at the far end of the second part of the container. The control lever for the pump is positioned between these two parts of the body in order for users to access it with their index and/or middle finger when the user's hand grips the first part of the body of the spray gun.

The rapid sealed inlet positioned at the far end of the second part of the body and container socket attachment is designed to be coupled either with a nozzle tip or extension shaft.

It is also forecast that the far section of the part of the body with the socket attachment for the container has an additional socket for the nozzle or tip when not in use.

The extension shaft includes structural tubing with an internal liquid intake pipe.

One end of the extension shaft houses a rapid sealed inlet fastened to the end of the structural tubing and connected to the internal liquid intake pipe, which is designed to be coupled to the rapid sealed inlet positioned on the body.

An additional nozzle tip connected internally to the liquid intake pipe is fitted close to the end of the opposite part of the extension shaft on the side surface of the structural piping.

A connecting or locking joint for a cleaning tool such as a cloth holder head, brush broom head, rubber blade for windows, etc. may be forecast as additional devices at the opposing end of the extension shaft to the end housing the rapid sealed inlet.

Additional extension shafts may be added, including structural piping with an internal intake pipe and high-speed sealed inlet at both ends.

The specific characteristics of the new liquid spray gun with detachable container and extension shaft auxiliary devices will be described later in greater detail, with reference to technical drawings attached as non-exhaustive examples.

FIG. 1 shows a schematic illustrated section of the spray gun.

The new spray gun comprises a body section (C) equipped with a detachable container part (S), a hand pump (C1) for liquids and detachable nozzle (C2).

The body (C) consists of two sections (Ca, Cb), which are inclined towards one another. The first section (Ca) comprises a handle to allow the user to grip the body (C). The second section (Cb) has a shape similar to a U and consists of a socket to couple the body to the detachable liquid container (S). The socket comprises a sealed inlet (C3) for the connection to the container (S) neck and mouth.

A flexible immersion pipe (C4) to feed liquid inside the container (S), passes through the sealed inlet (C3), connecting the internal part of the container (S) with a hand pump (C1) mounted on the body (C).

The hand pump (C1) is connected to the connection inlet (C3) and high-speed sealed inlet (C5) at the far extreme (Cba) of the second section (Cb) of the container (S) socket.

The control lever for the pump (C1) is positioned between these two sections (Ca and Cb) of the body (C) in order for users to access it with their index and/or middle finger when the user's hand grips the first part (Ca) of the body (C) of the spray gun.

The high-speed sealed inlet (C5) positioned at the end (Cba) of the second section (Cb) of the body (C) is designed to couple with either a nozzle tip (C2) or extension shaft (A, B).

The end (Cba) of the second section (Cb) of the body (C) is designed to house another socket (C6) for the nozzle tip (C2), when not in use.

FIG. 2 shows an initial extension shaft (A) comprising structural tubing (A1) with an internal liquid intake pipe (A2).

One end of the extension shaft (A) houses a high-speed sealed inlet (A3), which is fastened to the end of the structural tubing (A1) and connected to the internal liquid intake pipe (A2), in turn coupled with the high-speed sealed inlet (C5) mounted on the body (C).

An additional nozzle (A5) is mounted on the side surface of the structural tubing (A1) close to the other end (A4) of the extension shaft (A) and connected internally to the liquid intake pipe (A2).

A connecting or locking joint for a cleaning tool such as a cloth holder head, brush broom head, rubber blade for windows, etc. may be forecast as additional devices at the opposing end of the extension shaft (A4) to the end housing the rapid sealed inlet (A3).

FIG. 3 shows a further extension shaft (B) inserted between the new hand spray gun and the initial extension shaft (A) equipped with nozzle or tip (A5).

This additional extension shaft (B) comprises structural tubing (B1) with an internal liquid intake pipe (B2), and a high-speed sealed inlet at both ends (B3, B4).

The new liquid spray gun with detachable container and auxiliary extension shafts (A, B) has significant advantages.

The new spray gun can be used either independently—as with other spray guns currently on the market—or with one or more extension shafts or piping (A, B).

The new spray gun can be potentially equipped with an extension shaft or pipe (A) with nozzle or tip (A5) and used with a brush broom head or cleaning cloth holder, thereby allowing users to clean floors and similar surfaces thoroughly, without having to bend down and with less need to use hands.

The new spray gun can be used to clean windows or glass display cases, even those positioned above head height by using one or more extensions (A, B) for the upper part of the window or display case the spray gun on its own with a cloth or rubber blade for the lower part of the window or display case.

The aforementioned general guidelines and principles are sufficient for experts in the field to develop an application along the lines of the instructions given, which can be adapted to existing devices without compromising this innovative original concept.

Therefore, the following claims are made, based on the aforementioned description and enclosed technical drawings.

1. A new liquid spray gun, comprising a hand-held body section equipped with a container part, a hand pump, detachable nozzle, and a flexible immersion pipe to connect the inside of the container with the hand pump. The device is characterised by the fact that the nozzle is detachable and that the body of the new spray gun has a high-speed sealed inlet socket connected to the pump to attach and connect either the nozzle or an extension shaft when in use.

2. The liquid spray gun, as in claim 1, characterised by the fact that the extension shaft connected to the high-speed sealed inlet attachment of the spray gun body comprises structural tubing with an internal liquid intake pipe. Furthermore, a high-speed sealed inlet is positioned at the end of the extension shaft, locked into position at the end of the structural tubing and connected with the internal liquid intake pipe in order to couple with the high-speed sealed inlet on the body. At the opposing end of the extension shaft, there is an additional nozzle connected internally with the liquid intake pipe.

3. The liquid spray gun, as in claim 2, characterised by the fact that the end part of the extension shaft at the opposing end to the high-speed sealed inlet is designed in order to be coupled either directly or by means of a coupling and locking device with a cleaning appliance.

4. The liquid spray gun, as in claim 2, characterised by the fact that the device comprises at least a second extension shaft which is inserted between the high-speed sealed inlet of the spray gun body and the initial extension shaft equipped with a nozzle. This auxiliary second extension shaft comprises structural tubing with an internal liquid intake pipe, and high-speed sealed inlets on both outer ends.

5. The liquid spray gun, as in claim 4, characterised by the fact that the second section of the spray gun body is designed with an additional seat to attach the nozzle tip when not in use.
